(19) United States
(12) Patent Application Publication
(10) Pub. No.: US 2021/0004809 A1
(43) Pub. Date: Jan. 7, 2021

(54) FRAUD PREVENTION FOR PAYMENT INSTRUMENTS

(71) Applicant: GOOGLE LLC, Mountain View, CA (US)

(72) Inventors: Vishu Goyal, Mountain View, CA (US); Diana Ioana Nistor, Los Altos, CA (US)

(21) Appl. No.: 16/503,949

(22) Filed: Jul. 5, 2019

(51) Int. Cl. G06Q 20/40; G06N 20/00

(52) U.S. Cl. CPC G06Q 20/4016; G06N 20/00

(57) ABSTRACT

Preventing fraud or misuse associated with payment instruments comprises a processor for training a machine-learning process based on historic data related to interactions of an instrument. The processor trains a machine-learning process based on historic data related to interactions of an instrument and instrument issuer with counter-parties and users. The processor receives a request to evaluate the instrument for a risk of fraud and enters the accessed data into the machine-learning process. The processor determines a first risk score based on the machine-learning process that is based on a likelihood that the instrument issuer will remit invoiced funds and a second risk score based on a likelihood that the instrument issuer will initiate chargebacks. The processor determines that a combination of the first and second risk score is higher than a configured threshold and instructs the requester not to interact with the instrument.

### TECHNICAL FIELD

The present disclosure relates to preventing fraud or misuse associated with payment instrument issuers. More specifically, a machine-learning model is trained and utilized to determine if a party in an interaction, such as a transaction, with a payment instrument class has an elevated risk of not completing the interaction or of the interaction being rescinded.

### BACKGROUND

In conventional systems, processing systems evaluate a particular user at a time of an interaction to determine if the interaction has a high risk based on user history with a particular instrument or other instruments. Interactions that are considered to have an elevated fraud risk may be rejected or sent for further evaluation. When instruments are rejected for an interaction, the interaction may be delayed or terminated while a suitable instrument is identified. When users apply to be associated with an instrument, issuers of the instrument analyze a history of the user and the user interactions and determine if the user is considered to have an elevated fraud risk.

### SUMMARY

Techniques herein provide computer-implemented methods to prevent fraud or misuse associated with payment instruments from instrument issuers. The methods include a processor for training a machine-learning process based on historic data related to interactions, such as transactions, of an instrument with counter-parties and users. The processor receives a request to evaluate the instrument for a risk of fraud and enters the accessed data into the machine-learning process. The processor determines a first risk score based on the machine-learning process that is based on a likelihood that the instrument will remit invoiced funds and a second risk score based on a likelihood that the instrument issuer will initiate chargebacks. The processor determines that a combination of the first and second risk score is greater than a configured threshold and instructs the requester not to interact with the instrument.

In certain other example aspects described herein, systems and computer program products to prevent fraud or misuse associated with instruments are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to prevent fraud associated with instruments, in accordance with certain examples.

FIG. 2 is a block flow diagram depicting a method to prevent fraud associated with instruments, in accordance with certain examples.

FIG. 3 is a block flow diagram depicting a method to analyze the instruments via a machine-learning model, in accordance with certain examples.

FIG. 4 is a block diagram depicting a computing machine and a module, in accordance with certain examples.

### DETAILED DESCRIPTION

### Overview

In certain examples, a machine-learning algorithm, process, software, or other machine-learning system is trained and utilized to analyze a payment instrument to determine if the instrument has an elevated risk of fraud. If the payment instrument is determined to pose an elevated risk of fraud or otherwise determined not to be a suitable payment instrument based on the recognized factors and characteristics, then the evaluation system will reject the instrument. If the payment instrument is a suitable payment instrument based on the circumstances and the accessed history, then the evaluation system approves the instrument for the intended use. Throughout the specification, the payment instrument may alternatively be referred to as an instrument and a transaction may be referred to as an interaction. The instrument may be a credit card, debit card, prepayed card, or any other suitable type of instrument.

The evaluation of the instrument is specific to the class or type of instrument itself and the issuer of the instrument. The evaluation is event-agnostic such that the evaluation may be undertaken at any time in the interaction process and by any suitable party of the interaction process. Unlike many transaction-specific fraud assessments, the evaluation is not related to a user history, a user computing device history, a merchant history, or any other party to the interaction other than the instrument and the instrument issuer, although introduction of those factors does not change the innovation and may be used as desired by a system administrator or other interested party. The instrument evaluated may be a class of instruments from a particular instrument issuer. For example, the class of instruments may include all instruments from the instrument issuer that provide a certain rewards program or certain credit limit. The class of instruments may include all instruments form the instrument issuer that include a special program with a particular merchant.

In an example, the instrument is a payment instrument, such as a credit card, debit card, store card, prepaid card, loyalty card, identification card, or any other suitable instrument. The instrument issuer is a bank or other institution that issues the instrument to users for use in interactions. The instrument evaluated may be a class of instruments from a particular instrument issuer. The class of instruments can include all instruments from the instrument issuer that provide a certain rewards program or certain credit limit. The class of instruments can include all instruments form the instrument issuer that include a special program with a particular merchant. Alternatively, the instrument is a particular instance of the instrument that is issued to a user.

The interaction is performed with a digital application on a user computing device. The digital application may be a digital wallet or similar application that the user employs to manage payment instruments and other instruments. The interaction may be a payment transaction, but other types of interactions may be used, such as a check-in, an access authorization, a ticket display, or any other suitable interaction.

In the examples described herein, the instrument will be described as a payment instrument or class of payment instrument, a digital application as a digital wallet, and an interaction as a transaction. These examples are used for illustrative purposes.

Any party to an interaction may make an event-agnostic request to evaluate an instrument for an elevated risk of fraud or misuse. The fraud or misuse includes a risk of an interaction not being completed, such as by the funds from a transaction not being proffered or by the transaction being rescinded at a later time. While a rescinded transaction, such as a “chargeback,” may not be fraudulent, repeated chargebacks may be an indication of misuse. Whether intentional fraud or merely misuse (together referred to herein as “fraud”), repeated chargebacks cost parties to the transaction time and funds to process and are undesirable. When an issuer is either associated with likely fraudulent users, is fraudulent itself, or has policies and procedures that create an environment with elevated fraud and misuse risks, then reasonable parties will avoid interacting with the issuer.

Any suitable party may host a machine-learning processor to analyze the instrument or make a request of a machine-learning processor. For example, a card network may desire to analyze the instrument or the instrument issuer and the interaction of the instrument issuer with counter-parties and users. Alternatively, a digital wallet system, a merchant, a user, or any other suitable party may desire to analyze the instrument or the instrument issuer.

The machine-learning processor can be a supervised machine-learning processor, such as a Gradient Boosting Decision Tree (“GBDT”). Other machine-learning processors could be used in alternative examples. GBDT is used in examples herein to represent the machine-learning processor, algorithm, or other machine-learning hardware or software.

The GBDT is trained based on data related specifically to the instrument issuer and the instrument that is issued. The data may be collected from card networks, digital wallet applications, user histories, merchant data, or any other suitable data that may help quantify and characterize instruments and instrument issuers, such as interactions of the instrument issuer with counter-parties and users. In a supervised learning environment, operators provide the GBDT with training data containing input/predictors related to the issuers and then provide the GBDT with preferred conclusions based on the data. The GBDT is able to recognize and learn the patterns from the data input. An alternate machine-learning technique or algorithm may analyze unsupervised data to search for rules, detect patterns, and summarize and group the data associated with the instrument. Any suitable machine-learning process, algorithm, or system may be used to learn about the data.

When a suitable party has an event that would require an interaction with the instrument or the instrument issuer, the party requests an evaluation of the instrument to determine if an interaction has an elevated risk of not being completed or of being rescinded. The party communicates data associated with the request to the evaluation system or any system that is hosting the GBDT.

The GBDT receives data that includes user history with the instrument, history of the issuer of the instrument, merchant interactions with the instrument, card network interactions with the issuer, chargebacks associated with the issuer, signals from other banks and payment processing systems related to the issuer, and any other suitable data associated with the issuer. The data is entered into the GBDT to allow the GBDT to learn about the instrument to enable more accurate assessments for the performance of the instrument. For example, the GBDT determines if the instrument issuer is likely to be fraudulent, involved in an excessive number of chargebacks, difficult to use, slow to pay invoices, or in any other way that interacting with the instrument issuer is a risk.

Two analyses may be performed by the GBDT. The first analysis is to determine if the issuer of the instrument is likely to complete the transaction and remit the required funds. The GBDT may provide a model or prediction of the likelihood that the issuer will be slow to pay or never pay invoices or other charges that the issuer agrees to pay. A second analysis is to determine if the issuer of the instrument is likely to rescind, or chargeback, a completed transaction. If either of these outcomes is likely, then the risk of conducting an interaction with the issuer is elevated.

A risk threshold is determined by the user, the digital wallet system, the digital wallet, a payment processing system, a card network, or any suitable party that desires to reduce fraudulent transactions. If the risk is greater than the threshold, then the evaluator system recommends that the instrument not be used for the current function. If the risk is less than or equal to the threshold, the evaluator system recommends that the instrument be used for the current function.

By using and relying on the methods and systems described herein, evaluator systems are able to better protect a user, card networks, digital wallets, merchants, and other parties from fraud and misuse with unsafe instruments from instrument issuers. Current evaluations are directed to user histories or other user interactions with counter-parties. By performing the risk analysis by focusing on the issuers of instruments, evaluations allow other parties to interactions to make informed decisions about issuers and avoid fraud and misuse. When an issuer is either associated with likely fraudulent users, is fraudulent itself, or has policies and procedures that create an environment with elevated fraud and misuse risks, then reasonable parties will avoid interacting with the issuer. Using machine-learning to perform the risk analysis allows more data to be processed and greater insights into the risk of the instrument to be learned than an analysis by a person or typical database would allow. The machine-learning will become more and more proficient at evaluating instrument risks as more data is acquired.

### Example System Architectures

Turning now to the drawings, in which like numerals represent like (but not necessarily identical) elements throughout the figures, example embodiments are described in detail.

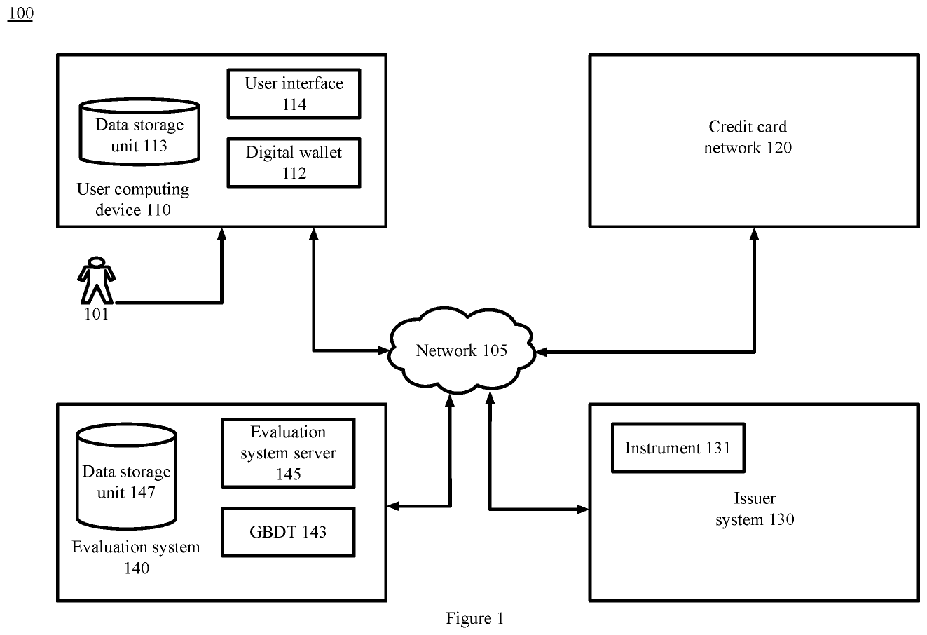

FIG. 1 is a block diagram depicting a system 100 to prevent fraud associated with instrument issuers 130.

As depicted in FIG. 1, the system 100 includes network computing devices/systems 110, 120, 130, and 140 that are configured to communicate with one another via one or more networks 105 or via any suitable communication technology.

Each network 105 includes a wired or wireless telecommunication means by which network devices (including devices 110, 120, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device/system 110, 120, 130, and 140 includes a computing device having a communication module capable of transmitting and receiving data over the network 105 or a similar network. For example, each network device 110, 120, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 120, 130, and 140 are operated by end-users or consumers, credit card network operators, issuer system operators, and evaluation system operators, respectively.

The user computing device 110 includes a user interface 114. The user interface 114 may be used to display a graphical user interface and other information to the user 101 to allow the user 101 to interact with the evaluation system 140 and others. The user interface 114 receives user input for displaying a digital wallet 112 and other applications.

The user computing device 110 also includes a data storage unit 113 accessible by the communication application (not shown) and one or more applications, such as the digital wallet 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

The digital wallet application 112 may encompass any application, hardware, software, or process the user computing device 110 may employ to assist the user 101 in completing a purchase transaction or other interaction. The digital wallet application module 112 can interact with a communication application, such as a web browser, or can be embodied as a companion application of a communication application. The digital wallet 112 may be provided to the user computing device 110 by a digital wallet system or otherwise associated with a digital wallet system. The digital wallet system may manage the operations, updates, and other functions of the digital wallet 112.

An example evaluation system 140 comprises an evaluation system server 145, a data storage unit 147, and a machine-learning computing system, such as a Gradient Boosting Decision Tree (“GBDT”) 143.

In an example embodiment, the evaluation system server 145 communicates with the credit card network 120, the issuer system 130, the user computing device 110, or other systems over network 105 to request and receive data related to card instruments, transactions, interactions, and other suitable data. The digital evaluation system 140 may provide data in real time to payment processing systems (not pictured) or the credit card network 120 to facilitate transactions.

In an example embodiment, the data storage unit 147 can include any local or remote data storage structure accessible to the evaluation system 140 suitable for storing information. In an example embodiment, the data storage unit 147 stores encrypted information.

The GBDT 143 represents any type of neural network computing system or other computing system that employs any machine-learning process or algorithm. The GBDT 143 is able to receive data from many varied sources and use the data to interpret patterns and characterize features of users 101, instruments, issuers 130, and others involved in the transaction process. The GBDT 143 is able to continually or periodically update the received information in a manner that allows the data presented by the evaluation system 140 to become more useful and accurate as more data is received and stored. The GBDT 143 may be a function or computing device of the evaluation system 140 that is used by the evaluation system 140 to perform some or all of the functions herein that are described as being performed by the evaluation system 140 or the evaluation system server 145.

Alternatively, the GBDT 143 may be hosted by a third party system, the digital wallet 112, or any other suitable host. The GBDT 143 represents an example of a machine-learning processor or algorithm. Any other suitable process may be used, such as a different supervised learning process, an unsupervised learning process, or reinforcement learning.

A credit card network 120 represents any suitable card network utilized for conducting transactions. A credit card network 120 facilitates transactions between merchants and credit card networks 120. In an example, the credit card network 120 decides where credit cards can be accepted, approves transactions, and facilitates payments.

An issuer system 130 may be a bank or other institution that issues instruments 131, such as credit cards, debit cards, prepaid cards, and other instruments. In an example, the card issuer system 130 approves credit card applications, sets terms for user, issues the physical and digital cards, and provides funds for transactions. The instrument 131 evaluated may be a class of instruments 131 from a particular instrument issuer 130. For example, the class of instruments 131 may include all instruments from the instrument issuer that provide a certain rewards program or certain credit limit. The class of instruments 131 may include all instruments form the instrument issuer 130 that include a special program with a particular merchant. In other examples, the instrument is a particular instance of the instrument 131 that is issued to a user 101.

It will be appreciated that the network connections shown are examples and other means of establishing a communications link between the computers and devices can be used. Moreover, those having ordinary skill in the art having the benefit of the present disclosure will appreciate that the issuer system 130, the credit card network 120, the evaluation system 140, and the user computing device 110 illustrated in FIG. 1 can have any of several other suitable computer system configurations. For example, a user computing device 110 can be embodied as a mobile phone or handheld computer, and may not include all the components described above.

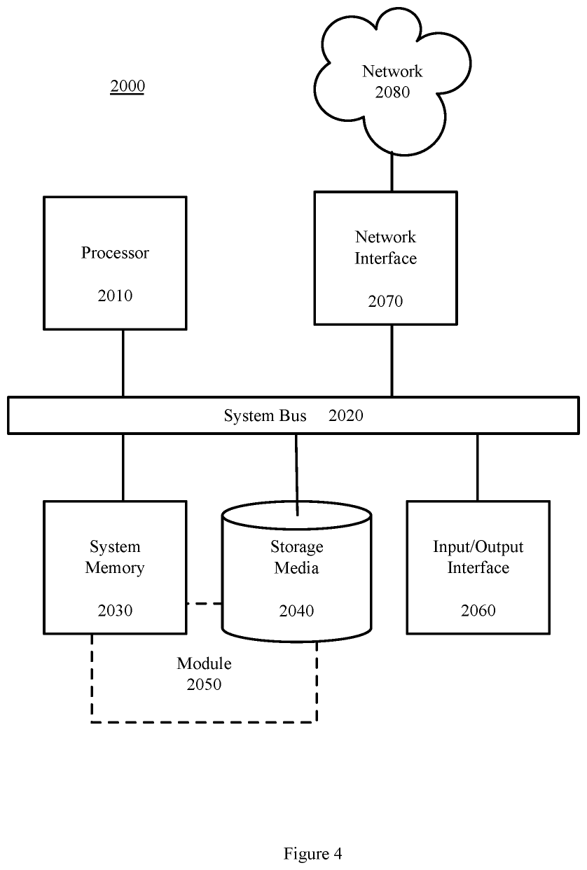

In example embodiments, the network computing devices and any other computing machines associated with the technology presented herein may be any type of computing machine such as, but not limited to, those discussed in more detail with respect to FIG. 4. Furthermore, any functions, applications, or components associated with any of these computing machines, such as those described herein or any others (for example, scripts, web content, software, firmware, hardware, or modules) associated with the technology presented herein, may by any of the components discussed in more detail with respect to FIG. 4. The computing machines discussed herein may communicate with one another, as well as with other computing machines or communication systems over one or more networks, such as network 105. The network 105 may include any type of data or communications network, including any of the network technology discussed with respect to FIG. 4.

### Example Processes

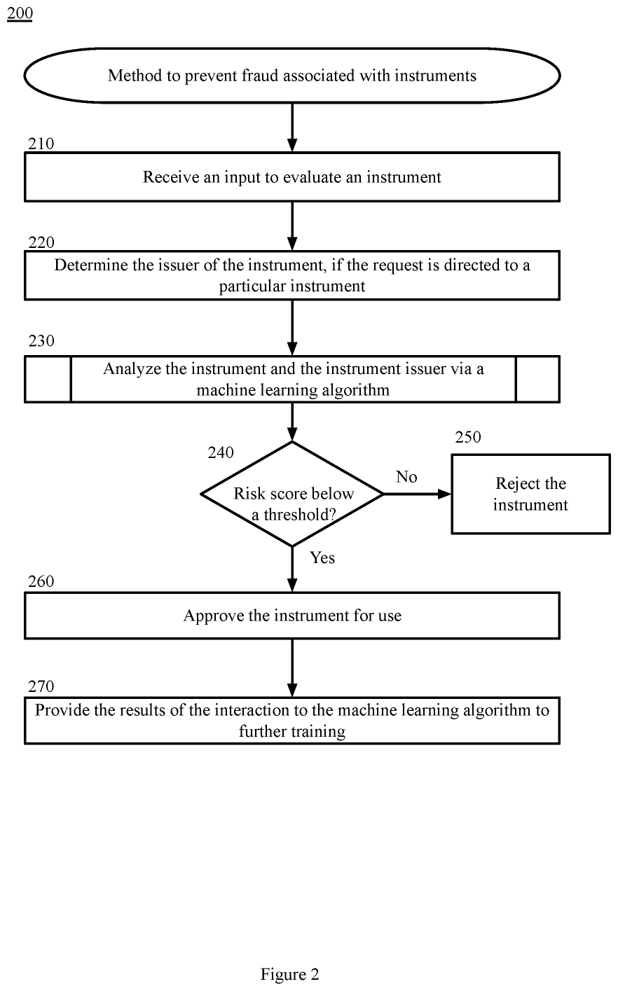

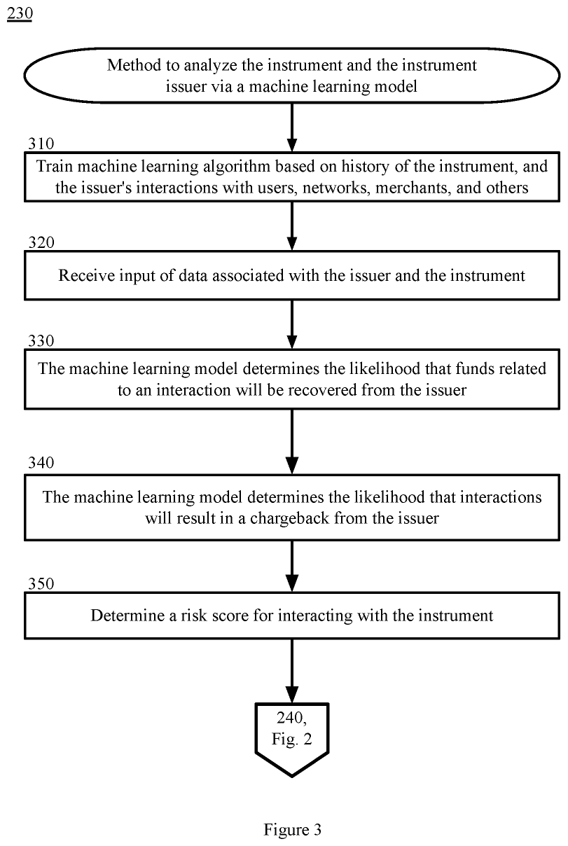

The example methods illustrated in FIGS. 2-3 are described hereinafter with respect to the components of the example operating environment 100. The example methods of FIGS. 2-3 may also be performed with other systems and in other environments. The operations described with respect to any of the FIGS. 2-3 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block flow diagram depicting a method 200 to prevent fraud associated with instruments 131, in accordance with certain example embodiments.

In block 210, an evaluation system 140 receives an input to evaluate an instrument 131. In the example, the evaluation system 140 is indicated as a separate entity, but the functions of the evaluation system 140 may be performed by any suitable party that hosts the GBDT 143, such as the credit card network 120 or a third party.

Any party to an interaction may make an event agnostic request to evaluate an instrument 131 from an issuer system 130 for an elevated risk of fraud or misuse of an instrument 131 associated with the issuer system 130. For example, the digital wallet 112 may communicated freely with the evaluation system 140 over an Internet connection or other connection to request the evaluation before accepting an instrument 131 associated with the issuer system 130. A credit card network 120 may communicate the request to the evaluation system 140 before allowing the issuer system 130 to use the credit card network 120 for credit transactions. A merchant system (not shown) may communicate the request to the evaluation system 140 before allowing the issuer system 130 to conduct transactions at a merchant location.

The requesting party communicates the request to the evaluation system 140 via any suitable technology, such as a network connection over the Internet. The request may include an identification of the issuer system 130, a specific instrument 131, the purpose of the request, and any other suitable information.

In block 220, if the request is directed to a particular instrument 131 or class of instrument 131, the evaluation system 140 determines the issuer system 130 of the instrument. In an example, the evaluation system 140 analyzes the instrument identification number, metadata associated with the instrument 131, collateral data associated with the instrument 131, or any other suitable data for identifying the issuer system 130. Any suitable manner of determining the issuer system 130 of the instrument may be used.

In block 230, the evaluation system 140 analyzes the instrument issuer 130 and the instrument 131 via a machine-learning algorithm. The details of block 230 are described in greater detail with respect to method 230 of FIG. 3.

FIG. 3 is a block flow diagram depicting a method to analyze the instrument issuer 130 and the instrument 131 via a machine-learning algorithm, processor, model, or other machine-learning process, in accordance with certain examples. Any type of machine-learning algorithm, processor, model, or other machine-learning process may be represented herein by the term machine-learning processor or alternatively any of the terms algorithm, processor, model, or other machine-learning process.

In block 310, the evaluation system 140 trains a machine-learning processor based on a history of a plurality of existing instruments 131, and the issuer 130 interactions with a plurality of users, networks, merchants, and others. The evaluation system 140 trains a machine-learning processor with data about credit card reliability, fraud, chargebacks, reputations, ease of use, and other suitable factors from any available sources. Specifically, the evaluation system 140 trains the processor to recognize whether an issuer system 130 poses an elevated risk of an interaction not being completed, such as by the funds from a transaction not being proffered or by the transaction being rescinded at a later time.

In an example, the machine-learning processor is a supervised machine-learning processor, such as a Gradient Boosting Decision Tree (“GBDT”) 143. Other machine-learning processors could be used in alternative examples. GBDT 143 is used in examples herein to represent the machine-learning processor, algorithm, or other machine-learning hardware or software. The GBDT 143 may be hosted by a third party system, the digital wallet 112, or any other suitable host. The GBDT 143 represents an example of a machine-learning process or algorithm. Any other suitable process may be used, such as a different supervised learning process, an unsupervised learning process, or reinforcement learning.

The GBDT 143 represents any type of neural network computing system or other computing system that employs any machine-learning process or algorithm. The GBDT 143 is able to receive data from many varied sources and use the data to interpret patterns and characterize features of users 101, instruments 131, issuer systems 130, and others involved in the transaction process. The GBDT 143 is able to continually or periodically update the received information in a manner that allows the data presented by the evaluation system 140 to become more useful as more data is received and stored. The GBDT 143 may be a function or computing device of the evaluation system 140 that is used by the evaluation system 140 to perform some or all of the functions herein that are described as being performed by the evaluation system 140 or the evaluation system server 145.

The GBDT 143 is trained based on data from instrument issuer systems 130, credit card networks 120, digital wallet applications 112, merchant data, or any other suitable data that may help quantify and characterize instruments 131 and instrument issuers 130. In a supervised learning environment, operators provide the GBDT 143 with training data containing input/predictors related to the issuers and then provide the GBDT 143 with preferred conclusions based on the data. The GBDT 143 is able to recognize and learn the patterns from the data input. An alternate machine-learning technique or algorithm may analyze unsupervised data to search for rules, detect patterns, and summarize and group the data associated with the instrument. Any suitable machine-learning process, algorithm, or system may be used to learn about the data.

In block 320, the evaluation system 140 receives an input of data associated with the requested issuer system 130. The data may be gathered from any suitable sources, such as merchants, credit card networks 120, financial institutions, payment processing networks, or other sources. The data may be specific to the issuer system 130 with results of previous interactions. The evaluation system 140 inputs the received data into the GBDT 143. The data is entered into the GBDT 143 to allow the GBDT 143 to learn about the issuer system 130 to enable more accurate assessments for the performance of the issuer system 130.

In block 330, the GBDT 143 determines the likelihood that funds related to an interaction will be recovered from the issuer system 130. Based on the model, algorithm, decision tree, or other system used to by the GBDT 143, the GBDT 143 analyzes the proposed instrument and determines the rates at which the issuer system 130 will remit invoiced funds. The GBDT 143 may predict a percentage likelihood of receiving funds, an estimate of how the issuer system 130 will compare to other issuers, or a rating based on any suitable scale.

In block 340, the GBDT 143 determines the likelihood that interactions will result in a chargeback from the issuer system 130. Based on the model, algorithm, decision tree, or other system used to by the GBDT 143, the GBDT 143 analyzes the proposed instrument 131 and determines the rates at which the issuer system 130 will submit chargebacks, request a refund, or otherwise rescind interactions. The GBDT 143 may predict a percentage likelihood, an estimate of how the issuer system 130 will compare to other issuers, or a rating based on any suitable scale.

In block 350, the GBDT 143 determines a risk score for interacting with the issuer system 130. The risk scores separately or jointly use the likelihood that the instrument 131 will remit required funds, will likely encounter a high number of chargebacks, or will likely pose any other risk of fraud or misuse. The risk score may be configured to any suitable scale, such as a 0-100 score, a letter grade, a poor-to-great Likert scale, or any other suitable risk score scale. The scores for the different likelihoods may be scored separately or combined into an overall risk score.

A risk threshold is determined by the user 101, the evaluation system 140, a digital wallet 112, a payment processing system, or any suitable party that desires to reduce fraudulent interactions. If the risk score is, for example, based on a 1-100 scale, the threshold may be set at a suitable number, such as 70.

From block 350, the method 230 returns to block 240 of FIG. 2.

Returning to FIG. 2, in block 240, the evaluation system 140 determines if the risk score is below a threshold. The overall risk score may be used, or either or both of the individual risk scores may be used. For example, if the scale is 0-100, the threshold is 70, and the overall risk score is 50, then the risk score is below the threshold. If the risk score is not below the threshold, then the method 230 follows the NO path to block 250. In another example, both of the individual risk scores must be below the threshold for the decision of block 240 to follow the YES path. That is, if either the risk score directed to the likelihood of the issuer system 130 remitting required funds or the risk score directed to the likelihood of the issuer system 130 submitting excessive chargebacks is not lower than the threshold, then block 240 proceeds to follow the NO path.

In the example, a higher risk score means that the issuer system 130 is more likely to experience fraud or misuse. In an alternative example, a lower risk score means that the issuer system 130 is more likely to experience fraud or misuse. The use of the risk score would be adjusted accordingly.

In block 250, if the risk score is not below the threshold, then the evaluation system 140 recommends not interacting with the instrument 131. The evaluation system 140 provides a notification to the requester that the instrument 131 has an elevated risk of fraud or misuse. The requester may attempt the addition at a later time, select an alternate issuer system, or perform any other suitable action in response to the notification. If the evaluation system 140 is the requester, then the evaluation system 140 may elect not to proceed with interacting with the instrument 131. For example, the evaluation system 140 does not allow the instrument 131 to conduct transactions with the evaluation system 140.

If the risk score, or any combination of the individual risk scores is below the threshold, then the method 230 follows the YES path to block 260.

In block 260, if the risk score (or any combination of the risk scores) is below the threshold, then the evaluation system 140 recommends interacting with the instrument 131. The evaluation system 140 provides a notification to the requester that the issuer system 130 does not have an elevated risk of fraud or misuse. The requester may proceed to interact with the instrument 131 as intended. If the evaluation system 140 is the requester, then the evaluation system 140 may proceed with interacting with the issuer system 130. For example, the evaluation system 140 proceeds to allow the issuer system 130 to conduct transactions with the evaluation system 140.

In block 270, any suitable party provides the results of the interaction to the machine-learning algorithm for further training. Based on continuous or periodic updating of transactions of the user 101, the instrument 131, the credit card network 120, the card issuer 130, a merchant, or any others parties, the GBDT 143 is able to improve the models or algorithms for future risk scores. When a subsequent requester attempts to interact with the issuer system 130, the GBDT 143 is able to more accurately predict the risk due to the additional training materials.

### Example Systems

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to prevent fraud or misuse associated with a class of payment instruments based on risk associated with an issuer of the class of payment instruments, the computer-implemented method comprising:
receiving, outside of a payment transaction by one or more computing devices, a request to evaluate a payment instrument from a payment instrument issuer for a risk of fraud, the request comprising information associated with the payment instrument;
determining, by the one or more computing devices, the payment instrument issuer for the payment instrument based on the information associated with the payment instrument;
generating, by the one or more computing devices using one or more machine-learning models trained based on data associated with the payment instrument issuer and one or more classes of payment instruments, a first risk score of interacting with the payment instrument, the first risk score being based on a likelihood that the payment instrument issuer associated with the payment instrument will remit invoiced funds in association with usage of the payment instrument;
generating, by the one or more computing devices using the one or more machine-learning models, a second risk score of interacting with the payment instrument, the second risk score being based on a likelihood that the payment instrument issuer associated with the payment instrument will initiate chargebacks in association with usage of the payment instrument;
determining, by the one or more computing devices, that a combination of the first risk score and the second risk score is beyond a configured threshold for evaluating risk associated with issuers of payment instruments; and
providing, by the one or more computing devices based on determining that the combination of the first risk score and the second risk score is beyond the configured threshold, a response to the request comprising instructions that recommend not to interact with the payment instrument.

2. The computer-implemented method of claim 1, further comprising:
training the one or more machine-learning models based on data related to interactions involving payment instruments from a payment instrument class of the payment instrument.

3. The computer-implemented method of claim 1, further comprising:
receiving outside of a payment transaction by one or more of the computing devices, a second request to evaluate a second payment instrument for a risk of fraud, the request comprising information associated with the second payment instrument;
determining, by the one or more computing devices using the one or more machine learning models, a third risk score of interacting with the second payment instrument, the third risk score being based on a likelihood that a payment instrument issuer associated with the second payment instrument will remit invoiced funds in association with usage of the second payment instrument;
determining, by the one or more computing devices using the one or more machine learning models, a fourth risk score of interacting with the second payment instrument, the fourth risk score being based on a likelihood that the payment instrument issuer associated with the second payment instrument will initiate chargebacks in association with usage of the second payment instrument;
determining, by the one or more computing devices, that a combination of the third risk score and the fourth risk score is acceptable in view of the configured threshold for evaluating risk associated with issuers of payment instruments; and
providing, by the one or more computing devices based on determining that the combination of the third risk score and the fourth risk score is acceptable in view of the configured threshold, a response to the second request comprising an indication permitting interaction with the second payment instrument.

4. The computer-implemented method of claim 3, further comprising utilizing the second payment instrument in a subsequent interaction involving one or more parties.

5. The computer-implemented method of claim 1, further comprising:
determining that either the first risk score or the second risk score is beyond a second configured threshold for evaluating risk associated with issuers of payment instruments.

6. The computer-implemented method of claim 1, wherein the configured threshold for evaluating risk associated with issuers of payment instruments is configured by one or more of a user, a payment processing system, or a card network.

7. (canceled)

8. (canceled)

9. The computer-implemented method of claim 2, further comprising:
providing, by the one or more computing devices, results of one or more subsequent transactions involving the payment instrument to the one or more machine-learning models in association with further training the one or more machine-learning models.

10. The computer-implemented method of claim 2, wherein the one or more machine-learning models comprise a supervised machine-learning model.

11. The computer-implemented method of claim 2, wherein the one or more machine-learning models comprise a gradient boosting decision tree model.

12. The computer-implemented method of claim 2, wherein the one or more machine-learning models comprise an unsupervised machine-learning model.

13. The computer-implemented method of claim 1, wherein the request is received from a digital application associated with a user computing device based on an interaction involving the digital application and the payment instrument.

14. A system to prevent fraud or misuse associated with a class of payment instruments based on risk associated with an issuer of the class of payment instruments, the system comprising:
one or more processors; and
a memory comprising computer-readable instructions that, when executed by the one or more processors, cause the one or more processors to perform operations comprising:
receiving, outside of a payment transaction by one or more computing devices, a request to evaluate a payment instrument from a payment instrument issuer for a risk of fraud, the request comprising information associated with the payment instrument;
determining, by the one or more computing devices, the payment instrument issuer for the payment instrument based on the information associated with the payment instrument;
generating, by the one or more computing devices using one or more machine-learning models trained based on data associated with the payment instrument issuer and one or more classes of payment instruments, a first risk score of interacting with the payment instrument, the first risk score being based on a likelihood that the payment instrument issuer associated with the payment instrument will remit invoiced funds in association with usage of the payment instrument;
generating, by the one or more computing devices using the one or more machine-learning models, a second risk score of interacting with the payment instrument, the second risk score being based on a likelihood that the payment instrument issuer associated with the payment instrument will initiate chargebacks in association with usage of the payment instrument;
determining, by the one or more computing devices, that a combination of the first risk score and the second risk score is beyond a configured threshold for evaluating risk associated with issuers of payment instruments; and
providing, by the one or more computing devices based on determining that the combination of the first risk score and the second risk score is beyond the configured threshold, a response to the request comprising instructions that recommend not to interact with the payment instrument.

15. The system of claim 14, wherein the operations further comprise:
training the one or more machine-learning models based on data related to interactions involving payment instruments from a payment instrument class of the payment instrument.

16. The system of claim 14, wherein the operations further comprise:
receiving, outside of a payment transaction by one or more of the computing devices, a second request to evaluate a second payment instrument for a risk of fraud, the request comprising information associated with the second payment instrument;
determining, by the one or more computing devices using the one or more machine learning models, a third risk score of interacting with the second payment instrument, the third risk score being based on a likelihood that a payment instrument issuer associated with the second payment instrument will remit invoiced funds in association with usage of the second payment instrument;
determining, by the one or more computing devices using the one or more machine learning models, a fourth risk score of interacting with the second payment instrument, the fourth risk score being based on a likelihood that the payment instrument issuer associated with the second payment instrument will initiate chargebacks in association with usage of the second payment instrument;
determining, by the one or more computing devices, that a combination of the third risk score and the fourth risk score is acceptable in view of the configured threshold for evaluating risk associated with issuers of payment instruments; and
providing, by the one or more computing devices based on determining that the combination of the third risk score and the fourth risk score is acceptable in view of the configured threshold, a response to the second request comprising an indication permitting interaction with the second payment instrument.

17. The system of claim 14, wherein the operations further comprise:
providing, by the one or more computing devices, results of one or more subsequent transactions involving the payment instrument to the one or more machine-learning models in association with further training the one or more machine-learning models.

18. The system of claim 14, wherein the request is received from a digital payment application associated with a digital wallet on a user computing device based on an interaction involving the digital wallet and the payment instrument on the user computing device.

19. A non-transitory computer-readable medium comprising computer-readable instructions, that when executed by a processor, cause the processor to perform operations comprising:
receiving, outside of a payment transaction by one or more computing devices, a request to evaluate a payment instrument from a payment instrument issuer for a risk of fraud, the request comprising information associated with the payment instrument;
determining, by the one or more computing devices, the payment instrument issuer for the payment instrument based on the information associated with the payment instrument;
generating, by the one or more computing devices using one or more machine-learning models trained based on data associated with the payment instrument issuer and one or more classes of payment instruments, a first risk score of interacting with the payment instrument, the first risk score being based on a likelihood that the payment instrument issuer associated with the payment instrument will remit invoiced funds in association with usage of the payment instrument;
generating, by the one or more computing devices using the one or more machine-learning models, a second risk score of interacting with the payment instrument, the second risk score being based on a likelihood that the payment instrument issuer associated with the payment instrument will initiate chargebacks in association with usage of the payment instrument;
determining, by the one or more computing devices, that a combination of the first risk score and the second risk score is beyond a configured threshold for evaluating risk associated with issuers of payment instruments; and
providing, by the one or more computing devices based on determining that the combination of the first risk score and the second risk score is beyond the configured threshold, a response to the request comprising instructions that recommend not to interact with the payment instrument.

20. The non-transitory computer-readable medium of claim 19, wherein the operations further comprise:
training the one or more machine-learning models based on data related to interactions involving payment instruments from a payment instrument class of the payment instrument.

21. The non-transitory computer-readable medium of claim 19, wherein the operations further comprise:
receiving, outside of a payment transaction by one or more of the computing devices, a second request to evaluate a second payment instrument for a risk of fraud, the request comprising information associated with the second payment instrument;
determining, by the one or more computing devices using the one or more machine learning models, a third risk score of interacting with the second payment instrument, the third risk score being based on a likelihood that a payment instrument issuer associated with the second payment instrument will remit invoiced funds in association with usage of the second payment instrument;
determining, by the one or more computing devices using the one or more machine learning models, a fourth risk score of interacting with the second payment instrument, the fourth risk score being based on a likelihood that the payment instrument issuer associated with the second payment instrument will initiate chargebacks in association with usage of the second payment instrument;
determining, by the one or more computing devices, that a combination of the third risk score and the fourth risk score is acceptable in view of the configured threshold for evaluating risk associated with issuers of payment instruments; and
providing, by the one or more computing devices based on determining that the combination of the third risk score and the fourth risk score is acceptable in view of the configured threshold, a response to the second request comprising an indication permitting interaction with the second payment instrument.

22. The non-transitory computer-readable medium of claim 19, wherein the operations further comprise:
providing, by the one or more computing devices, results of one or more subsequent transactions involving the payment instrument to the one or more machine-learning models in association with further training the one or more machine-learning models.
